(19) United States
(12) Patent Application Publication
(10) Pub. No.: US 2002/0100132 A1
(43) Pub. Date: Aug. 1, 2002

(54) Porous polymeric substrate treatment device and method

(76) Inventors: Daniel T. McMullen, El Dorado Hills, CA (US); Kristan G. Bahten, Gold River, CA (US); James S. Innes, Cameron Park, CA (US); Vincent J. Catalano, Folsom, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/774,398

(22) Filed: Jan. 30, 2001

(51) Int. Cl. B08B 1/04; B29D 31/00

(52) U.S. Cl. 15/102; 15/230; 15/230.16; 15/244.3; 15/244.4; 264/243

(57) ABSTRACT

A device for treating surfaces of substrates utilized in electronics manufacturing includes a resilient skin encasing a porous polymeric interior. The resilient skin overlies the exterior surface of the brush, and is typically characterized by a higher density, a smaller pore size, and a lower porosity than the interior material of the brush. The skin may serve to distribute physical stress over a larger area, protecting raised or recessed brush features from abrasion and wear. The porosity of the skin may also influence the movement of liquids through the brush, ensuring the homogenous dispensing of cleaning fluids. The resilient skin may be formed during or subsequent to a brush fabrication process such as molding, extrusion, or milling, and can be accomplished through the application of heat, chemicals, or radiation.

### BACKGROUND OF THE INVENTION

The present invention relates to the manufacture of objects. More particularly, the present invention provides a device for cleaning substrates used in electronics, such as in the fabrication of integrated circuits from substrates of semiconductor materials. By way of example, the present invention is applied to the manufacture of substrates for integrated circuits, but it will be recognized that the invention has a wider range of applicability and can also be applied to the manufacture of other types of substrates such as memory hard disks, flat panel displays, and the like.

In the manufacture of electronic devices, the presence of particulate contamination is a serious issue. Particulate contamination can cause a wide variety of problems such as mechanical and/or electrical failures. These failures often take the form of reliability and functional problems of electronic devices formed on a substrate. For example, particulate contamination is one of the main sources for lower device yields, increasing the cost of an average functional IC being manufactured.

Particulate contamination can be introduced to the substrate during the fabrication process, for example during the application of abrasive slurry during chemical mechanical planarization (CMP) steps, or during etching processes which leave behind unwanted residue. Each of these processes often introduce the aforementioned impurities onto the surface of the substrate. These impurities generally become bound to the substrate and must often be removed.

A variety of techniques have been used or proposed to remove the impurities. One technique is a conventional rinser, which uses a cascading rinsing fluid such as deionized water to carry away particulate contamination. The cascade rinse utilizes a rinse tank which includes inner and outer chambers, each separated by a partition. In most cases, rinse water flows from a water source into the inner chamber. The rinse water from the inner chamber cascades into the outer chamber. An in-process substrate is typically rinsed in the cascade rinser by dipping it into the rinse water of the inner chamber. A limitation with the cascade rinser is that “dirty water” often exists in the first chamber. The dirty water typically has “particles” which can attach themselves to the substrate. These particles often cause defects in the substrate, thereby reducing the number of defect-less substrates in the manufacturing process. Another limitation with the cascade rinser is that particles having a strong attraction to the substrate cannot be removed by the rinse fluid. Accordingly, the cascade rinse often cannot remove particles from the substrate.

An alternative technique for removing particles is a scrubbing process. The scrubbing technique uses a scrubber with scrubbing brushes or rollers. An example of a scrubber that uses scrubbing brushes is the Synergy™CMP cleaning system manufactured by Lam Research Corporation of Fremont, Calif. This scrubber has the pair of scrubbing brushes that are cylindrical in shape. The brushes are biased against a substrate and rotated to remove particles.

Although the aforementioned scrubbing brushes have been partly effective in removing particles and/or contamination, a variety of limitations still exist with their use in conjunction with the manufacture of conventional semiconductor substrates. One such limitation is introduction of particle contamination to the substrate from exposed ends of a scrubbing brush.

FIG. 1 shows a simplified perspective view of a brush scrubbing apparatus in which arm 10 engages edge 12a of substrate 12 and moves the substrate laterally along length 14 between rotating brushes 16. Brushes 16, however, are typically formed by cutting a longer piece of polyvinyl acetal (PVA) material, such that brush interior 16a having a porous cell-type structure is exposed at the end. Because of its open cell type structure, brush interior 16a may be prone to shed particles onto substrate 12 as the substrate passes by the end of the brush.

Moreover, brushes 16 typically include a plurality of projecting nodules 18. These nodules are generally already formed as a part of the master PVA member from which brush 16 is cut. If the master PVA piece is cut into sections at nodules 18, only a part of a nodule may remain on the exterior surface of the brush. This cutting may thus weaken the nodule structure, such that the nodule may be fragile and contribute particulate contamination to the passing substrate.

Based upon the above, it is seen that an improved material for treatment of substrates is highly desired.

### SUMMARY OF THE INVENTION

Embodiments of the present invention provide a device for treatment of surfaces of substrates, for example as are utilized in the formation of integrated circuits and data storage. In one exemplary embodiment, the present invention provides an improved scrubbing device which includes a resilient skin that encloses a porous polymeric interior portion. The resilient skin is of controllable thickness, structure, and texture, and overlies the exterior surface of the brush, including any projecting nodules. The skin thus isolates interior porous brush portions from contact with the substrate and maintains intact nodule portions resulting from fabrication of the brush.

One embodiment of a scrubbing device in accordance with the present invention comprises a shaped member comprising an inner portion of a porous polymeric material, and an outer surface for removing residual particles from an object. A resilient skin overlies the outer surface, the resilient skin having a higher density and a lower porosity than the inner portion.

One embodiment of a method for making a scrubbing brush comprises forming an elongated master brush including a resilient outer skin, and cutting the elongated master brush to form a brush portion having an exposed interior region lacking a skin. The interior region is sealed with a second resilient skin, wherein the first skin and the second skin are continuous with each other and form a substantially particle-free surface.

These and other embodiments of the present invention, as well as its advantages and features are described in more detail in conjunction with the text below and attached Figures.

### BRIEF DESCRIPTION OF THE DRAWINGS

FIG. 1 shows a simplified perspective view of a conventional scrubbing apparatus in which a substrate is passed along a length of a scrubbing brush.

FIG. 2 shows a simplified exploded view of a scrubbing brush bearing a resilient skin in accordance with one embodiment of the present invention.

FIG. 3 shows a simplified cross-sectional view of a scrubbing brush bearing a resilient skin in accordance with an alternative embodiment of the present invention.

FIG. 4 shows a simplified scanning electron microscope image of the cross-section of the interface between the resilient skin and an internal porous portion of a brush in accordance with one embodiment of the present invention.

FIG. 5A shows a side view of an alternative embodiment of a brush in accordance with the present invention which features a reduced diameter portion.

FIG. 5B, which is a cross-sectional view of FIG. 5A along line 5B-5B′.

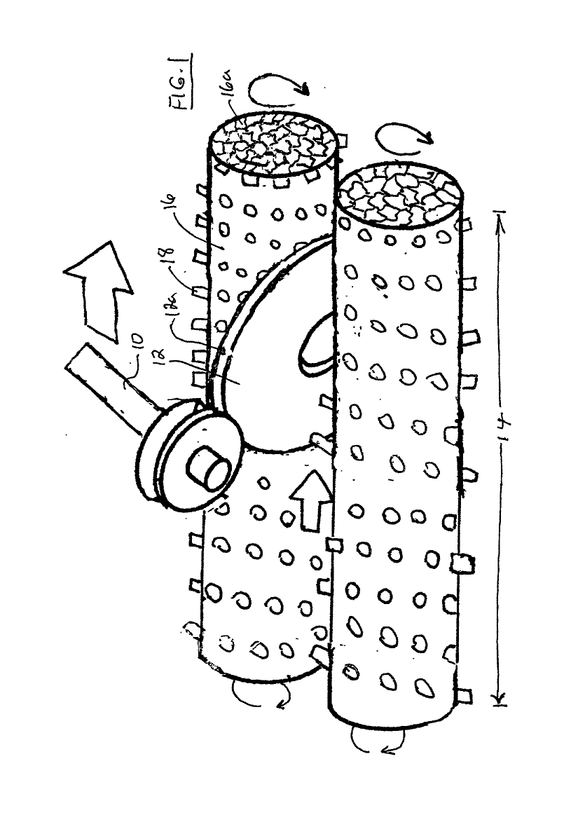

### DESCRIPTION OF THE SPECIFIC EMBODIMENTS

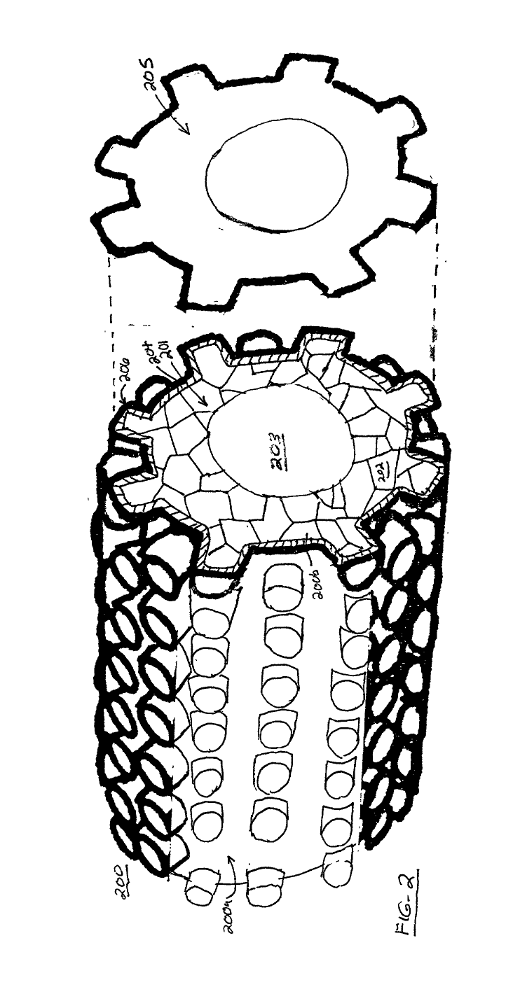

FIG. 2 shows a simplified exploded view of a scrubbing brush in accordance with one embodiment of the present invention. Brush 200 comprises a porous polymeric material 202 encased within first resilient skin portion 204. Porous polymeric material 202 may be formed from polyvinyl acetal, polyurethane, silicone and other polymer or copolymer materials.

Bore 203 extends through porous polymeric material 202. Annular ends 201 of brush 200 are encased within a second, annular resilient skin portion 205. Outer surface 200a of brush 200 includes a plurality of projecting nodules 206 also covered by resilient skin portions 204 and 205 as shown.

Porous polymeric material 202 can be composed of polyvinyl acetal, polyvinyl chloride, polyurethane, silicone, or any other suitable porous polymeric material compatible with the substrate to be treated and the chemistry being utilized to treat the substrate. As described above, porous polymeric material 202 typically exhibits a cell-type structure.

The resilient skin exhibits a different physical structure than the interior porous portion of the brush. Specifically, the difference in physical structure can be characterized in several ways, including increased density, lower porosity, and smaller pore size.

One characteristic of the resilient skin material is density. In accordance with one embodiment of the present invention, a PVA brush includes a resilient skin having a density of between about 0.5 to 1.3 g/cm³. By contrast, the density of the interior of the PVA brush is between about 0.07 to 0.10 g/cm³.

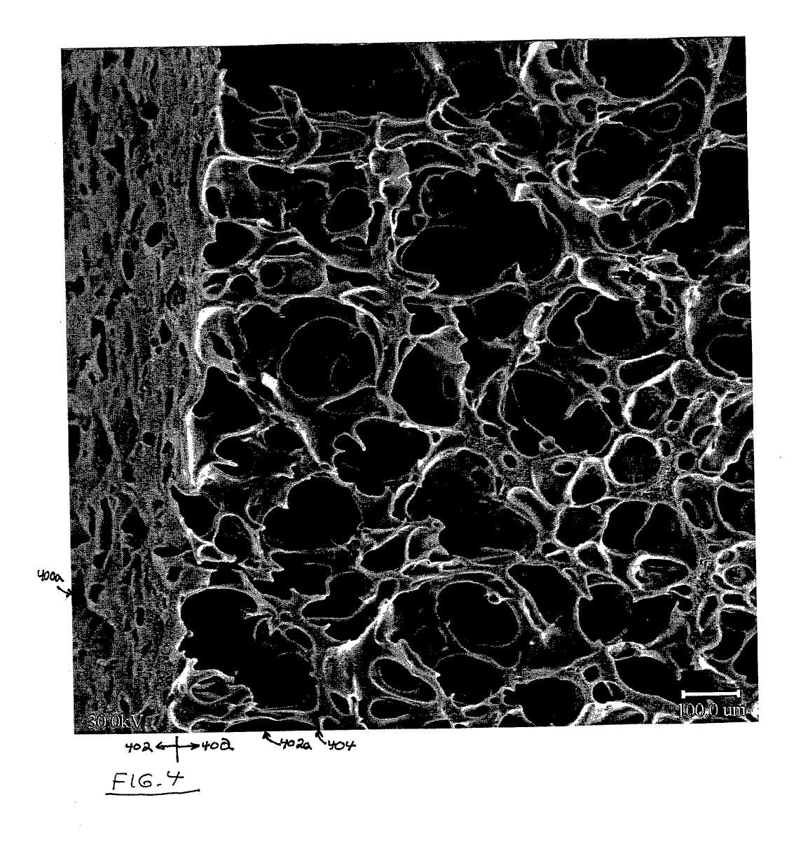

Another characteristic of the skin material is pore size. Pore size reflects the size of the pores in the material, and may be measured from high power photographs of cross-sections of the material. FIG. 4 shows a scanning electron micrograph (SEM) image at a power of 30 kV of a cross-section of a PVA brush at the interface between skin 400 and the porous brush interior 402. Such a skin may be formed with a cure temperature range of between 40-220° C. for a period of from on the order of minutes to days.

FIG. 4 shows that the structure of brush interior 402 includes large pores 402a separated by struts 404. Pores 402a of brush interior 402 are much larger than pores 400a of skin 400. Both of these factors reveal the significantly smaller pore size of skin 400 versus brush interior 402. For example, where the scrubbing brush is formed from polyvinyl acetal, the average pore size of the porous polymeric interior is between about 110 and 150 μm, while the average pore size of the brush skin is between about 40 and 60 Another characteristic of the resilient skin material is porosity. Porosity describes the percentage of the volume of the brush occupied by the pores, and may be measured by perfusion of helium through the material. Porosity of the resilient skin of a brush formed from polyvinyl acetal is about 50%. By contrast, porosity of the interior PVA material of the brush was between about 80-95%.

The above-referenced characteristics of the resilient skin can offer significant advantages during cleaning processes.

For example, one important role of the brush is to exert physical force against the surface of the substrate, either directly through contact with the substrate, or indirectly through a lubricating (cleaning) fluid. However, the cell struts of the brush interior shown in FIG. 4 are not especially durable under concentrated load or abrasion conditions. The increased density of the resilient skin material thus may play an important role in distributing surface stresses over a larger area of the brush. Absent the resilient skin, individual struts forming the walls of the cells of the porous polymeric interior would likely be exposed to more intense forces than where the dense skin distributes the force. Struts of a skinless brush would thus be more susceptible to wear resulting from abrasion. Such wear could lead to contamination of the substrate by fragments of the brush interior.

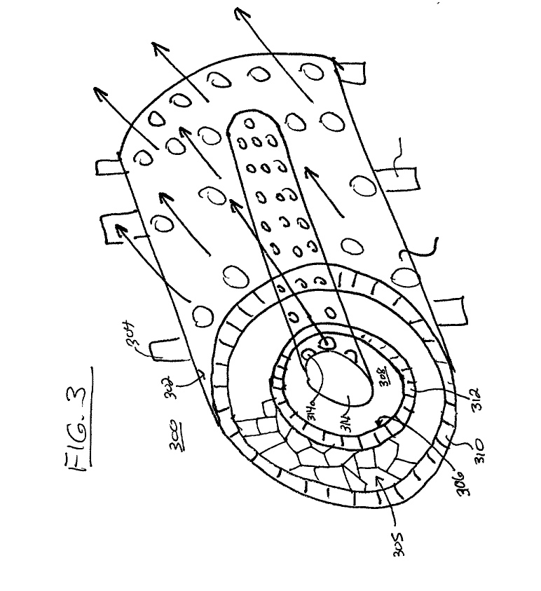

Another role of the brush during cleaning may be to dispense liquid cleaning material. This is described in detail in co-pending U.S. Nonprovisional patent application No. 09/586,665, filed Jun. 1, 2000 and hereby incorporated by reference. Accordingly, another advantage of resilient skin is that its porosity can be used to influence the flow of fluids through the brush. This aspect of the present invention is illustrated below in conjunction with FIG. 3.

FIG. 3 shows a simplified cross-sectional view of a scrubbing brush bearing a resilient skin in accordance with an alternative embodiment of the present invention. Brush 300 is cylindrical in shape and includes an exterior surface 302 bearing nodules 304, and an interior surface 306 defining bore 308. Internal porous polymeric material 305 having a typical open-celled structure is present between exterior surface 302 and interior surface 306.

Exterior surface 302 and nodules 304 of brush 300 are covered with first resilient skin portion 310 having a first porosity. Interior surface 306 is covered with second resilient skin portion 312 having a second porosity. During cleaning, a fluid may flow out of openings 314a in fluid flow member 314, and through second skin 312 into internal porous polymeric region 305. Once internal region 305 becomes saturated with fluid, the fluid flows out of first skin portion 310 to come into contact with a substrate.

By having second skin portion 312 exhibit greater porosity than first skin portion 310, the pressure drop across second skin 312 is lessened and fluid is able to enter brush interior 305 more easily. Moreover, less porous first skin 310 serves as a membrane to evenly distribute the flow of liquid through brush interior 305, resulting in even distribution of fluid delivered to the substrate through the brush.

Physical characteristics of the skin material may also facilitate implementation of texture on the brush. As described below, where the skin is formed by molding, texture on the surface of the mold may be transferred to the surface of the molded part. Skin texture can be useful in a number of applications. For example, during installation of a brush on a scrubbing apparatus, the bore is typically slipped around the end of a projection and secured by frictional contact. Enhanced roughness of an interior skin portion of the brush may aid in securing the brush to the scrubbing device.

A textured brush skin could also be used to influence friction factors and fluid dynamics on a microscopic level at the brush-substrate interface. Properties such as shear forces, mass transport, and surface chemistry could be influenced and controlled by the texture of the brush skin.

The coarseness of a textured brush skin could be tailored to achieve optimum results in removing particle contamination from a given type of substrate. The texture of the resilient skin can vary in roughness, and can be random or patterned in nature. In one embodiment of the present invention, the location and character of the texturing could be determined by the presence of corresponding textured features on the surface of the mold. Optimal skin texture for a given brush could be a function of 1) the material properties of the brush, 2) the nature of the substrate being treated, 3) the chemistry being utilized to treat the substrate, 4) the nature of the materials sought to be removed from the substrate, and 5) operational parameters for the specific scrubbing device.

Alternatively, or in conjunction with a brush having enhanced surface roughness, a brush could be shaped by molding, milling, or extrusion to include an interior having recesses configured to receive corresponding raised features on the outside surface of a core or mandrel portion. In this manner, the interior shape of the brush could be keyed to the exterior shape of the core or mandrel in order to ensure proper alignment of the brush, and to prevent bunching or slippage of the brush on the core during use. The presence of a resilient skin overlying the recesses in the brush would help strengthen the brush and prevent particulate contamination from recess-edge brush regions subject to additional stress because of their shape.

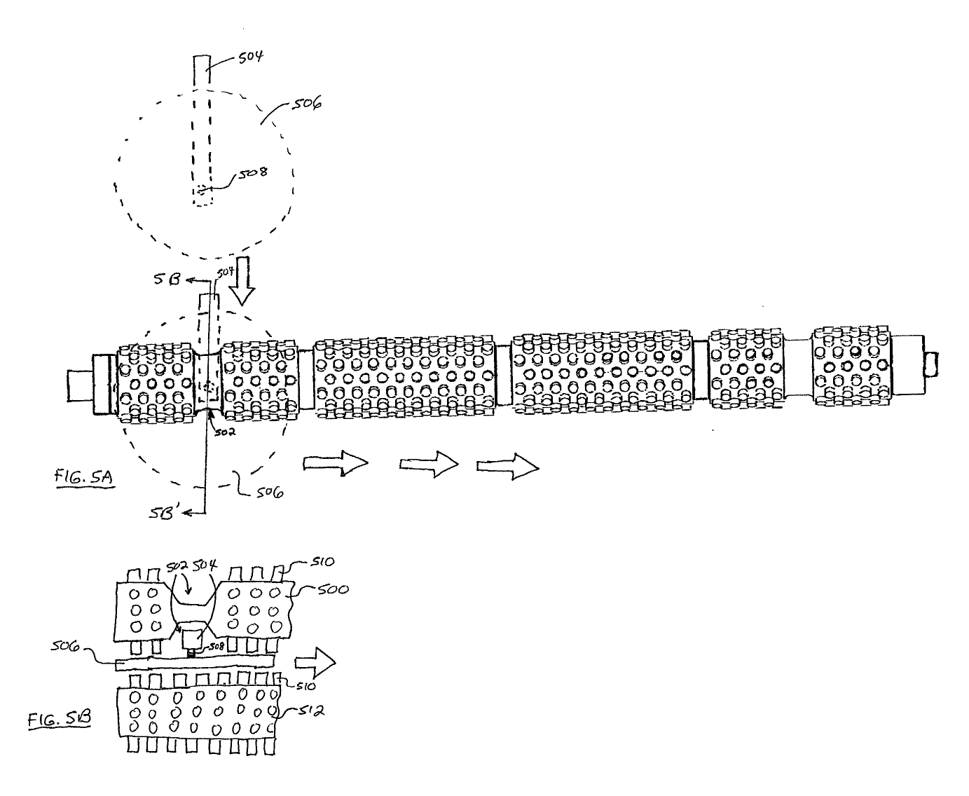

Alternatively, or in conjunction with a brush featuring a shaped inner surface, a brush in accordance with the present invention could also exhibit a shaped outer surface. FIG. 5A shows a side view of an alternative embodiment of brush 500 in accordance with the present invention, which features a reduced diameter portion 502. Reduced diameter portion 502 allows for the insertion of arm 504 carrying disk-like substrate 506 at contact point 508.

The role of reduced diameter portion 502 is further illustrated in connection with FIG. 5B, which is a cross-sectional view of FIG. 5A along line 5B-5B′. Arm 504 moves downward carrying substrate 506, and places substrate 506 between nodules 510 of brush 500 and second brush 512. Upon release of substrate 506 from arm 504 and withdrawal of arm 504 from reduced diameter portion 502, rotation of brushes 500 and 512 cleans the substrate and causes the substrate to move horizontally along the length of the brushes. The presence of the resilient skin over the reduced diameter portions of the brush will strengthen these portions against degradation and particle contamination caused by stress.

The resilient skin material of the present invention may be formed by a number of processes. Where the brush is formed by molding, the resilient skin may result from thermal interaction between the surface of the mold and precursor polymeric material within the mold. In such a case, a temperature differential at the point of contact between the mold and the polymeric material could result in an increased density and decreased porosity of the molded material itself. Alternatively, the resilient skin may be produced by coating an interior mold surface with a separate material that is itself thermally cured or reacts with the porous polymeric material to form the resilient skin during the molding process. The materials of construction chosen for the mold can have a significant impact on the resulting skin. Surface interactions between the mold interface and the polymer mix will affect the wetting of the mold and/or act as a site for skin formation.

A scrubbing brush having a resilient skin may also be formed using an extrusion process. Where extrusion is used to form the brush, the porous polymeric material may be extruded through an opening covered by a film comprising the skin material, in a manner analogous to formation of skin around a sausage.

A scrubbing brush having a resilient skin may also be machined from a block of foam. In contrast with molded parts typically having softened, rounded edges, brushes formed by machining typically have relatively sharp edges that are susceptible to wear. As a result of this wear, particle contamination may be enhanced for substrates that are in contact with these edges. Thus in accordance with embodiments of the present invention, the resilient skin, or portions of the resilient skin, may be added subsequent to brush formation processes such as milling.

In one embodiment of the present invention, the skin may be produced by applying a protective coating to exposed exterior surfaces of the already-formed brush. In an alternative embodiment of the present invention, a first portion of the skin may be created during formation of a master elongated porous polymeric piece, with the second skin portion formed over ends of the brush section exposed by cutting of the master elongated polymeric piece. In such an alternative embodiment the skin may cover the exposed ends of the porous polymeric member (as shown by second, annular resilient skin portion 205 of FIG. 2) thereby preventing particulate contamination from occurring from these ends.

Where the skin is formed following a molding process, the skin may result from chemical interaction with the existing molded porous polymeric material, for example by dipping the molded member into a chemical bath. Alternatively, the skin may form through thermal interaction, for example by heating the molded member in a furnace, by cutting the shorter piece from the elongated master using a heated wire, or by applying a heated cap to the exposed ends to produce a cauterizing effect. Such an end cap could further be engraved with an identification mark such as a part number, a part manufacturer, and/or an applicable patent number, offering yet another advantage of the present invention.

In addition to exposure to heat or chemicals, the skin may be formed through other processes, such as interaction with electromagnetic radiation, for example from application of a laser beam.

The above description is illustrative and not restrictive, and as such should not be limiting to the claims as described herein. While the above embodiments are generally described in terms of use in manufacturing semiconductor substrates, the invention has a much broader range of applicability. For example, the present invention could be applied to brushes used in a manufacturing process for flat panel displays, optical devices, and other devices requiring a high degree of cleanliness.

Moreover, while the resilient skin is described in the above embodiments primarily in terms of porosity and roughness, other attributes could be utilized to describe the resilient skin. For example, during a brush compression-relaxation event, the “resiliency bounce” of a skin material describes the ability of the material to dissipate compression energy versus the amount of energy transferred back to the surroundings upon relaxation of the brush after compression. One method of measuring resiliency bounce is set forth by American Society for Testing and Materials (ASTM) test D 3574, wherein a steel ball of known diameter and weight is dropped from a fixed height onto a specimen, and the height of the rebound measured as a percentage of the initial drop height. For applications involving cleaning of electronic substrates, a resiliency bounce of between 25-30% is preferable.

Another physical property characterizing the skin material is determination of the temperature and frequency dependence of the storage modulus, the loss modulus and the mechanical loss factor. These properties may be measured through Dynamic Mechanical Analysis (DMTA) utilizing the Advanced Rheometric Expansion System (ARES), manufactured by Rheometrics Scientific of Piscataway, N.J. If the time for full recovery of the skin material from a compression event is not sufficiently short, the material would be unsuitable for use in a particular application requiring repeated compression and expansion of the brush.

Yet another physical property characterizing the skin material is recovery time or hysteresis. Material recovery time or hysteresis should ideally be less than the time that it takes for the brush to undergo one full rotation. A brush rotating at 50 rpm would thus optimally have a recovery time of less than 0.02 minutes. A brush rotating at 1200 rpm would thus optimally have a recovery time of less than 8.3×10⁻⁴ minutes. This recovery time is a function of the elastic properties of the skin material as well as the centrifugal force operating to expand the brush outward as it rotates. The fluid present inside the brush while it is spinning increases this centrifugal force. The porosity or permeability of the skin will also influence the rate at which the material recovers from the centrifugal force due to the amount of resistance applied as the water flows through the skin. A more porous skin material may offer less resistance to the flow of fluid, reducing the impact of the centrifugal force on the membrane and counterbalancing material recovery time.

Compression set is another important property of the skin material. Compression set characterizes the degree to which the material recovers its original shape following a compression cycle. In order for a porous polymeric brush to be effective in a cleaning process, it must remain in contact with the substrate. Therefore, a compressive set of the material should be less than the normal compression the brush experiences under ordinary usage conditions. The compressive set should not exceed about 50% of the normal compression the brush experiences during the cleaning process. For example if a brush is compressed 2 mm from the relaxed state when in contact with the substrate, the compressive set of the brush skin material should be less than 1 mm. A steady state value for the compressive set should be achieved early in the cleaning process, or within about the first 25% of the cycle time for cleaning each individual substrate.

At high rotation speeds, the brush may swell due to the centrifugal forces exerted on the brush and liquid material contained within the brush. Elasticity and tensile strength of the skin play an important role in determining the shape and degree of deformation of the brush when it is rotating. Below a minimum tensile strength of the skin, the skin material may be torn apart. Above a maximum tensile strength of the skin, the skin material may be too rigid and fail to conform to the surface of the substrate being cleaned.

While the above is a full description of the specific embodiments in accordance with the present invention, various modifications, alternative constructions and equivalents may be used. Therefore, the above description and illustrations should not be taken as limiting the scope of the present invention which is defined by the appended claims.

What is claimed is:

1. A scrubbing device comprising:
a shaped member comprising an inner portion of a porous polymeric material and an outer surface for removing residual particles from an object; and
a resilient skin overlying the outer surface, the resilient skin having a higher density, a smaller average pore size, and a lower porosity than the inner portion.

2. The scrubbing device of claim 1 wherein the porous polymeric material comprises polyvinyl acetal material.

3. The scrubbing device of claim 2 wherein:
the density of the skin is greater than about 0.5 g/cm³, and the density of the inner portion is less than about 0.1 g/cm;
the average pore size of the skin is about 60 μm or less, and the average pore size of the inner portion is about 100 μm or greater; and
the porosity of the skin is approximately 50% or less, and the porosity of the inner portion is about 80% or greater.

4. The scrubbing device of claim 1 further comprising a plurality of nodules on the outer surface, the nodules covered with the skin to prevent particulate contamination.

5. The scrubbing device of claim 1 wherein the member is cut from a longer piece of porous polymeric material which results in an exposed end of the inner porous polymeric material.

6. The scrubbing device of claim 5 wherein the end is covered by the skin.

7. The scrubbing device of claim 1 wherein the skin is formed following a molding process forming the member.

8. The scrubbing device of claim 1 wherein the skin is formed following an extrusion process forming the member.

9. The scrubbing device of claim 1 wherein the skin is formed following a milling process forming the member.

10. The scrubbing device of claim 1 wherein the porous polymeric material comprises silicone material.

11. The scrubbing device of claim 1 wherein the porous polymeric material comprises a polyurethane material.

12. The scrubbing device of claim 1 wherein the porous polymeric material comprises a copolymer material.

13. The scrubbing device of claim 1 wherein said member is cylindrical in shape.

14. A scrubbing brush comprising:
an elongated member having an exterior surface and an interior surface, the interior surface defining a central bore extending at least part way through the elongated member, the central bore shaped to receive a fluid flowing member;
a first skin disposed on the exterior surface and characterized by a first porosity;
a second skin disposed on the interior surface and characterized by a second porosity, the first porosity less than the second porosity to promote a flow of fluid from the fluid flowing member across the second skin and to minimize a pressure drop across the second skin.

15. The scrubbing brush of claim 14 wherein the second skin features a surface roughness that enhances contact between the brush and the fluid flowing member.

16. A scrubbing brush comprising an elongated member having an exterior surface and an interior surface, the interior surface defining a central bore extending at least part way through the elongated member, the interior surface including a recess shaped to receive a corresponding raised feature of a core structure.

17. The scrubbing brush of claim 16 wherein a resilient skin is formed over the recess.

18. A scrubbing brush comprising an elongated member having an exterior surface and an interior surface, the interior surface defining a central bore extending at least part way through the elongated member, the exterior surface including a reduced diameter portion shaped to receive an arm for transporting a substrate.

19. The scrubbing brush of claim 18 wherein a resilient skin is formed over the reduced diameter portion.

20. A method for making a scrubbing brush comprising;
forming an elongated master brush including a resilient outer skin;
cutting the elongated master brush to form a brush portion having an exposed interior region lacking a skin; and
sealing the interior region with a second resilient skin, wherein the first skin and the second skin are continuous with each other and form a substantially particle free surface.

21. The method of claim 20 wherein sealing the interior region creates an identification mark.

22. The method of claim 21 wherein creating an identification mark comprises creating at least one of a part number, a part manufacturer, and an applicable patent number.

23. A method for fabricating a compressive treatment brush material comprising:
transferring the molding substance to a mold; and
curing the molding substance within the mold to form a resilient skin.

24. The method of claim 23 wherein the molding substance comprises polyvinyl acetal (PVA).

25. The method of claim 24 wherein curing the molding substance results in a skin having a density of greater than about 0.5 g/cm³, an average pore size of about 60 μm or less; and a porosity of about 50% or less, with an inner brush portion having a density of about 0.1 g/cm³ or less, an average pore size of about 100 μm or greater, and a porosity of about 80% or greater.
